(19) United States
(12) Patent Application Publication
(10) Pub. No.: US 2008/0002874 A1
(43) Pub. Date: Jan. 3, 2008

(54) Distinguishing reference image errors in optical inspections

(76) Inventor: Peter Fiekowsky, Los Altos, CA (US)

Correspondence Address: BEYER WEAVER LLP, P.O. BOX 70250, OAKLAND, CA, 94612-0250, US

(21) Appl. No.: 11/478,281

(22) Filed: Jun. 29, 2006

(51) Int. Cl. G06K 9/00

(52) U.S. Cl. 382/144

(57) ABSTRACT

Detecting defects in reference images used for optical inspections reduces false defect detections in the test image. Reference images are presumed perfect, but in practice contain defects. Defects in the reference image are detected by measuring the symmetry or randomness of pixels in the area of the suspected defect in both images. Measurements of the pixel intensity ranges, edge smoothness, and total edge slope in the two images are compared to determine if a suspect defect is actually in the reference image.

### FIELD OF THE INVENTION

The present invention relates generally to optical inspections. More specifically, the present invention relates to detecting defects in reference images in microlithography.

### BACKGROUND OF THE INVENTION

In the field of optical inspections, especially in microlithography, inspections are performed by comparing a sample or test image to a reference image and detecting differences. Reference images are presumed perfect, but in practice contain defects. Undetected defects in the reference image cause spurious or false defect detections in the test image.

The test image commonly comes from an optical system similar to a microscope with a camera. In the field of photographic mask (photomask) inspection in semiconductor microlithography, the test image can come from other sources of two-dimensional images, such as, but not limited to a SEM (scanning electron microscope) or an AFM (atomic force microscope). The reference image commonly comes from one of three sources: a) an image of a similar structure that is presumed defect free, b) a computer rendering of the design data for the structure being inspected, or c) an alternate imaging method of the actual structure being inspected.

In photomask inspection these reference sources provide the name of the inspection types, respectively a) “die-to-die” (D2D) inspections, b) “die-to-database” (DDB) inspections, and c) simultaneous transmitted and reflected (“STAR”) inspections-for a common case where transmitted and reflected images are modified and compared.

In D2D inspections the mask must have repeated patterns, such as multiple copies of a die, or chip pattern. The inspection tool scans each die on the mask and compares it with a nearby die that should be identical. Any errors detected must then be attributed to one of the two die. Sometimes this method is used to compare adjacent regions with identical designs within chips with repeating logic. These inspections could be called “gate-to-gate”, but the issues are the same as with D2D inspections. The proprietary algorithms now used generate many errors identifying the defective die.

In DDB inspections the design database of the mask is converted to an image in a process called “rendering,” similar to the rendering used to create animated video from the design of the objects in the video. The DDB rendering process is difficult because it must take into account the optical and imaging characteristics or “image transfer function” of the microscope used to acquire the test image. It must also take into account the transfer function of the mask writing process. Test data has shown that the biggest problem is adapting to illumination and scattering changes in the microscope itself.

STAR inspections use the transmitted light image as a reference for the reflected light image, or visa versa. The transmitted image is processed or “rendered” and compared to the reflected image with a proprietary algorithm. The most common problem with STAR inspections is that correct small chrome features such as corners appear to be defects due to errors in the rendering algorithm. Any other alternate imaging method, such as SEM or AFM, can be used to generate the test or reference image. Inspections based on other imaging methods may have many of the same problems as the STAR inspection as well as some new problems.

Reference image defects have two common causes: dirt or imperfections on the reference, or “golden” pattern (in the case of D2D inspections), and faulty rendering of correct design data to match the alignment, illumination and aberrations of the test image (in D2D, DDB and STAR inspections). In D2D and STAR inspections, focus and illumination errors in the reference image are treated as rendering errors.

Defects in the reference image cause false defect detections attributed to the test image when the test and reference images are compared. These false, or nuisance detections cause loss of productivity in inspection processes, especially when the number of nuisance defects exceeds the number of real defects, making the analysis of results difficult and causing operator fatigue.

### SUMMARY OF THE INVENTION

This invention describes a method for detecting defects in a reference image thereby reducing the frequency of false defects and increasing the efficiency of optical inspections. This method is described as used in semiconductor photomask inspection, but is also applicable to other image-based inspections, such as inspection of printed material where accuracy is critical, e.g., printed circuit boards, pharmaceutical labels and other documents.

The method is based on the assumption that defects are more random than the patterns being manufactured. Thus, if the reference image is more random (less symmetrical) than the suspect defect region of the test image, then the defect is in the reference image. Of course this does not prove that there is no defect in the test image, but it reduces the probability of a test image defect typically by a factor of a billion.

Patterns are distinguished into the following categories: 1) uniform clear or dark areas with no edge, 2) straight edges, 3) corners, 4) repeating complex patterns and 5) non-repeating complex patterns. Different pattern types require different analysis methods. Consider for example, a small dark spot in a clear area such as a defect caused by dirt. Normally the range of pixel intensities in the test image is large because of the dirt, but nearly zero on the reference image because this is a uniform clear area. If the pixel intensity range is higher in the reference image, then the defect must be in the reference image. This example is a simple case detected by the spatial non-linearity method discussed below.

Similarly, if a defect on a straight edge is reported from the inspection, but the edge in the test image is shown by image analysis to be perfectly straight as seen in FIGS. 2 and 3, then the edge in the reference image must have the defect. One method of performing such image analysis is to perform “sub-pixel edge following.” Using edge following, a threshold is selected, usually the average of the brightest and darkest pixel levels in the image, then the sub-pixel edge position is computed for each pixel next to the edge. Then the angles between each of these sub-pixel edge positions are compared. In a straight edge the angles will be approximately equal. In practice, with 8-bit pixels the variation is less than 2 degrees. Thus the defect must be in the reference image if the edge angles in the test image are the same within two degrees, but some of the edge angles in the reference image vary by more than two degrees.

Another method of performing such image analysis uses “spatial non-linearity.” In this method, a computed auto-reference image is created from the original image by performing a one-dimensional smoothing in the direction of the line. An auto-reference image is created both for the original test image and for the original reference image. Preferably, images are created only for the region of interest in the original image (i.e., the identified defect region), although the entire image may also be used. Next, the auto-reference of the reference image is subtracted from the reference image to obtain a maximum pixel intensity difference (MPID) value, and the auto-reference of the test image is subtracted from the test image to obtain another maximum pixel intensity difference value. The images may be subtracted to obtain a separate difference image, or the subtraction may simply occur pixel-by-pixel and keeping track of a running comparison of results. The subtraction resulting in a larger maximum pixel intensity difference value indicates where the defect lies. For example, if the MPID of the reference image subtraction results in a higher value, then the defect lies in the reference image.

There are two main causes of defects in the reference image: reference pattern errors and rendering errors. Reference pattern errors only occur in D2D inspections, where the inspection tool finds a defect but assigns the defect to the wrong image (or die). Rendering errors occur in all three inspection types.

In D2D inspections rendering errors can be caused by differences in focus or illumination in the images for the two compared positions, or by “stitching” errors in the reference image produced by the inspection tool. Stitching refers to the operation where two side-by-side images are combined (stitched together) to make a larger image, for example the image tiling seen in satellite images such as “Google Maps.” The stitching operation must take into account position errors due to optical distortion and mechanical errors as well as illumination and focus changes. Ideally, the border between images cannot be found. In practice, stitching errors are usually detected by seeing a jump in a straight line. Most commonly this jump is seen near an edge or on a diagonal line.

DDB inspections suffer from the same rendering issues as D2D inspections. The most common DDB rendering error is due to illumination corrections, while most D2D rendering errors are position correction errors (sub-pixel misalignment between test and reference images). DDB inspections sometimes suffer from poor rendering of the mask writing (or product printing) process. This mainly affects very fine patterns and very coarse patterns, probably because the rendering algorithm is optimized for the most common pattern size.

STAR inspections mainly suffer from rendering algorithms that do not work on certain types of patterns, especially narrow features, and corners that are ninety degrees or sharper. Reference image defects in STAR inspections are all called nuisance defects because the cause depends on unknown details of the STAR algorithm used in the inspection. In practice the reference image is not available because the STAR algorithms are proprietary, and only the defect locations are provided. A defect is therefore considered a “reference image defect” when a given defect location is found to be non-defective in the test image (because it is highly symmetrical), even though the reference image is not available.

### BRIEF DESCRIPTION OF THE DRAWINGS

The invention, together with further advantages thereof, may best be understood by reference to the following description taken in conjunction with the accompanying drawings in which:

FIG. 1 is a flow diagram describing an embodiment for distinguishing defects in images.

FIG. 2 is an example of an edge defect in the original image.

FIG. 3 is an example of the auto-reference image created from the original image in FIG. 2 by one-dimensional smoothing in the horizontal direction.

FIG. 4A is an example of an edge overshoot.

FIG. 4B is an edge intensity profile for the edge overshoot of FIG. 4A.

FIGS. 5A and 5B illustrate a computer system suitable for implementing embodiments of the present invention.

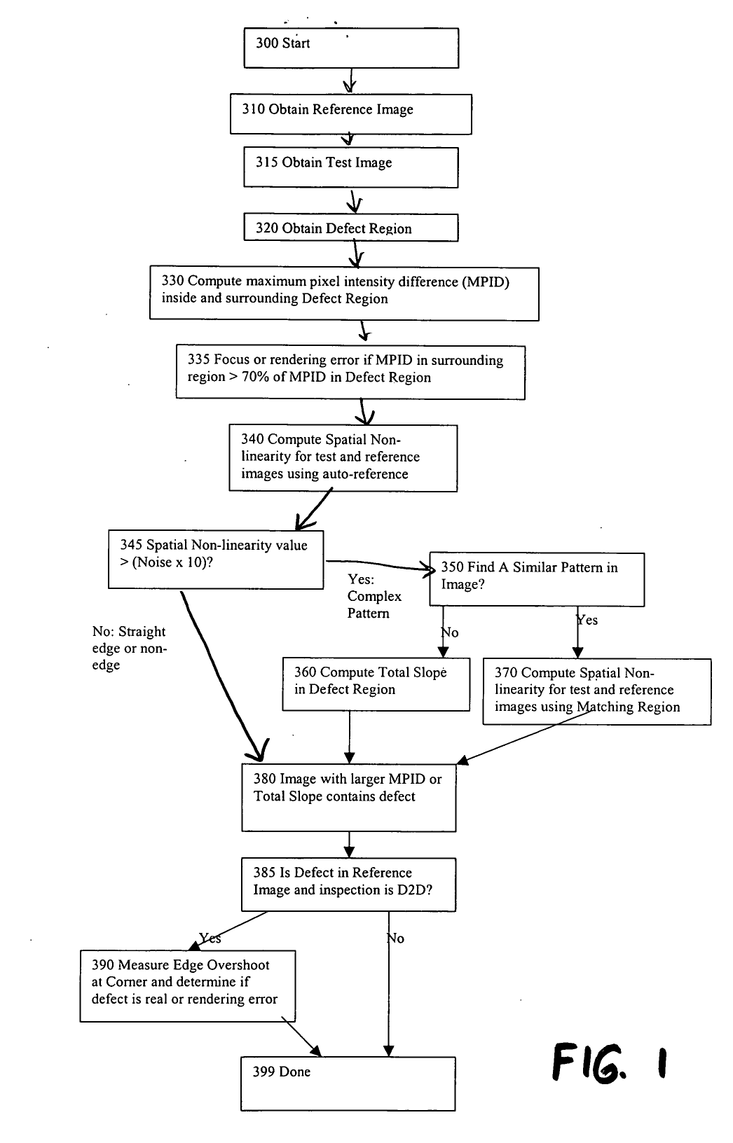

### DETAILED DESCRIPTION OF THE INVENTION

The method begins at 300 by receiving the images into a computer system for analysis. The test and reference images are acquired along with the defect region in steps 310 and 315. The reference image may be obtained in step 310 from any of the sources previously described, namely, 1) an image of a similar structure that is presumed defect free, 2) a computer rendering of the design data for the pattern being inspected, or 3) an alternate imaging method of the actual pattern being inspected. Devices that are used to produce this reference image include the KLA SLF, KLA 5xx, Orbot 8000 and NEC LM7000B inspection tools.

The test image may be obtained in step 315 from a photomask inspection system, generally the same inspection system that produced the reference image. Both images are typically grayscale and transferred via file from the inspection tool to the image analysis software, such as the software that may embody the steps herein described. Alternatively, the images may be transferred via a network socket or in hard copy.

The defect region is obtained in step 320 from the photomask inspection system. The defect region is defined as a block of pixels or as an irregular contiguous set of pixels that the inspection system listed as containing a possible defect. I.e., the defect region is a region that surrounds the suspected defect of the test image, or that surrounds a suspected defect in the reference image. Techniques for defining the defect region and for communicating it to a computer system are known to those of skill in the art.

Focus or large rendering errors are detected in steps 330 and 335 by comparing the maximum pixel intensity difference (MPID) between the test and reference images in two regions, 1) the defect region and 2) a narrow region surrounding the defect region. In the preferred method the surrounding region is 3 pixels wide. I.e., an MPID is obtained for the defect region and for the surrounding region. A real defect in the test image will normally be limited to the defect region. The defect is suspected to be a focus or large rendering error if the MPID in the surrounding region is more than approximately 70% of the MPID in the defect region.

A large defect could occasionally be a real manufacturing error such as over-etching that looks much like a rendering error such as defocus. Suspected focus or large rendering errors can be distinguished from such manufacturing errors by comparing the intensity gradients of the two images at an edge in the defect region. The gradient is computed by taking the maximum intensity difference between a pixel and its four adjacent pixels. If the gradients in the two images are nearly identical the defect is considered to be a real manufacturing error. The defect is considered to be a focus or large rendering error if the gradients differ by more than about 10%.

Spatial non-linearity is computed for both the test and reference images in step 340 by first creating an “auto-reference” image for each of the test and original reference images, and then computing the MPID between the original and its auto-reference image. This MPID value is used as the spatial non-linearity value. This technique is called an “auto-reference” technique because the test image or the original reference image itself is used to produce the auto-reference image.

Each auto-reference image is created by performing a one-dimensional smoothing of the original image (i.e., the test image or the reference image) in the defect region. This smoothing eliminates edge roughness such as defects but preserves any straight edges, thereby creating the auto-reference image. More than one auto-reference image may be created for each original image by performing one-dimensional smoothing in both the horizontal and vertical directions, as well as in other likely edge directions.

In one embodiment, the smoothing is performed in both the horizontal and vertical directions, resulting in two different auto-reference images for each original image, and two resulting MPID values for each original image (as described below). The lowest MPID value from all the auto-reference image calculations for a given original image is used as the spatial non-linearity value (the two values corresponding to an auto-reference image created by smoothing in one direction and to an auto-reference image created by smoothing in another direction). The lowest MPID value corresponds to smoothing in the direction of any straight lines.

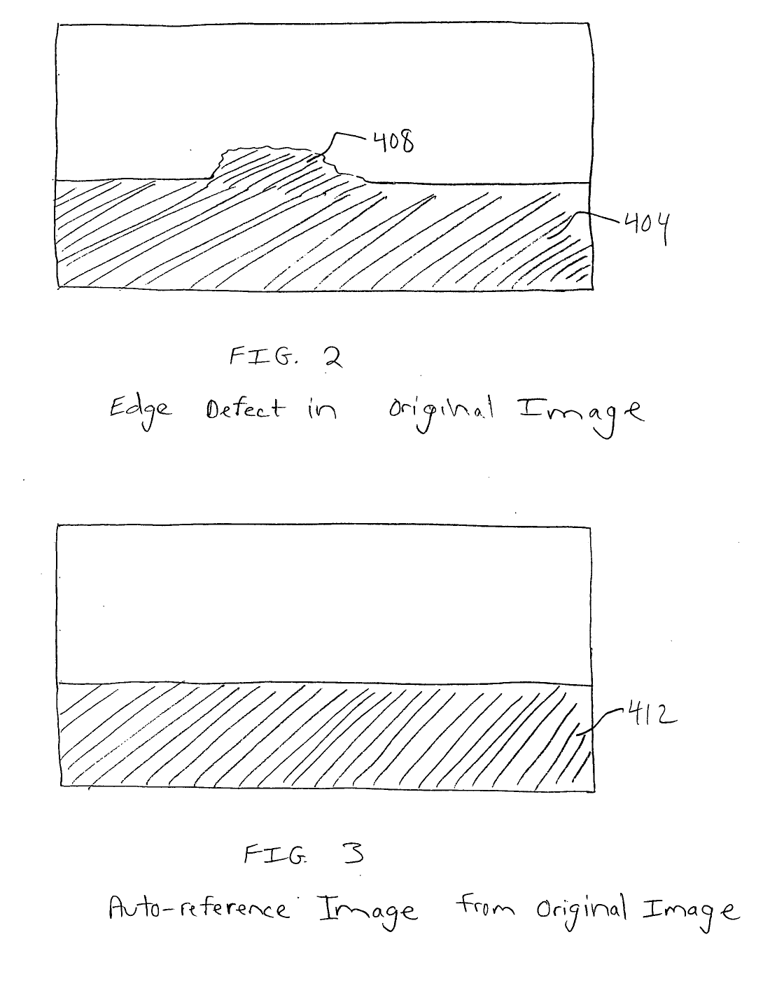

FIG. 2 illustrates an example of an edge defect 408 along a straight edge 404 of an original image. FIG. 3 illustrates an example of the auto-reference image 412 created from the image in FIG. 2 by one-dimensional smoothing in the horizontal direction.

Once an auto-reference image (or perhaps multiple auto-reference images as discussed above) is created for each of the test image and the original reference image, then the maximum pixel intensity difference (MPID) value can be created for each of the test image and the original reference image. The auto-reference image created from the test image is subtracted from the test image and a maximum pixel intensity difference is determined between the two images. Likewise, the auto-reference image created from the original reference image is subtracted from the reference image and an MPID is determined between these two images. The MPID for each of these operations is used as the spatial non-linearity value for each image. A comparison of the MPID for the test image and the original reference image can help determine where the real defect lies.

In this situation, it can be concluded that the real defect is in the image (test or original reference) having the higher spatial non-linearity value (i.e., the higher MPID value). We know this is true because we assume that the defect is more random, or less symmetrical than the manufactured pattern.

In step 345, if the spatial non-linearity value in both images is more than ten times the average pixel intensity noise in the test image then the defect region pattern is considered complex, such as a corner or a circle. In this case the intended pattern is non-linear, so the spatial non-linearity test is not well suited. In this case an identical, presumably non-defective pattern is used for the reference. Thus, a search for a similar pattern, is performed in the rest of the test image in step 350. The search can be implemented in many ways, including normalized two-dimensional correlation, or blob analysis, both methods known by one familiar with image processing. The preferred method is two-dimensional correlation because it works with any pattern, including color or grayscale patterns. The search also looks for a defect region pattern that is rotated or mirrored.

Normally the test image is searched for the similar pattern, although the reference image can be searched if there is reason to doubt the validity of the test image values, as is the case of a large defect.

If a matching region is found in step 350, then that matching region is sub-pixel aligned with the defect region of the original image (test or original reference) and used as a reference in step 370. This technique is similar to the technique described in step 340 except that a single matching region is used in place of each auto-reference image. This technique is called “auto-reference from repeat.” The MPID between the original image and the “auto-reference from repeat” matching region is computed for both the test and original reference images. These two MPID values are then used as the spatial non-linearity values in step 380 below.

But, if no matching region is found in step 350 then control moves to step 360. Thus, if the defect region pattern is complex with no matching region, then it can be difficult to determine whether the suspected defect is in the test image or in the reference image. Nevertheless, a technique is used in step 360 to provide a best guess. If the defect region contains an edge with one or more obtuse angles between about 135 and 180 degrees then the total intensity gradient (total slope) of the pixels in the defect region is computed for both images. This is a simple measure of image complexity.

In step 380 the image with the higher MPID value (coming from steps 345 or 370) or the image with the higher image complexity value, total slope, (coming from step 360) is concluded to be the image with the real defect.

Next, in step 385, if the inspection type is die-to-die and the defect is found in the reference image then control goes to step 390 to determine if the reference image defect is a real defect or a rendering error. If not, then the method ends at step 399.

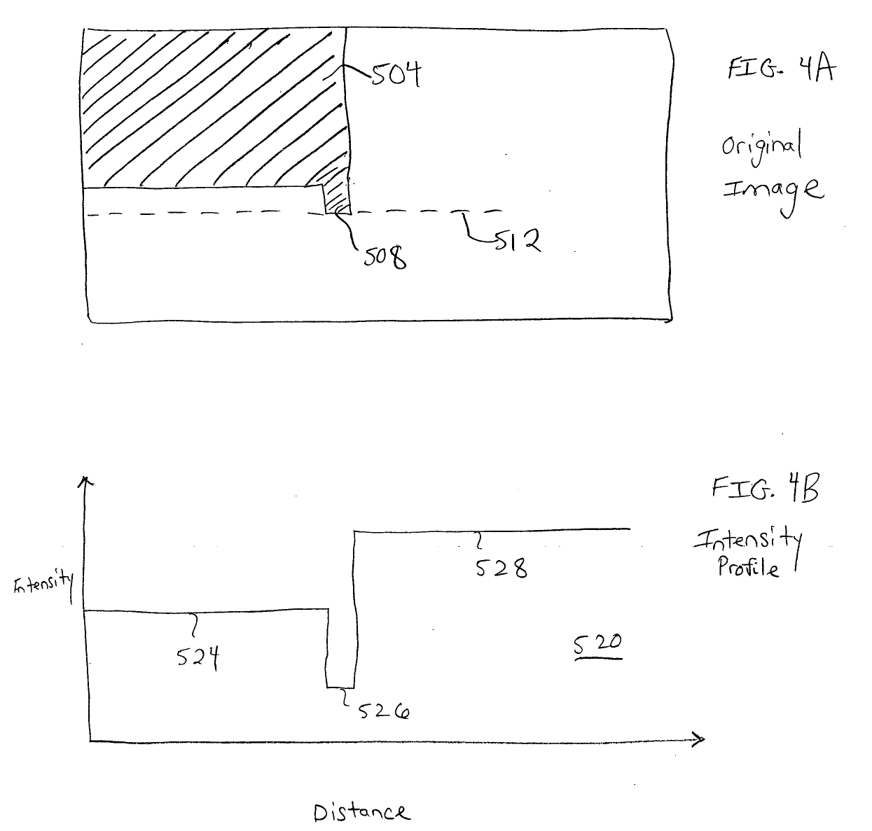

FIG. 4A illustrates a portion of a photomask 504 having an edge overshoot 508.

FIG. 4B is an intensity profile for the portion of photomask 504 from FIG. 4A. The profile is taken along line 512. The intensity is a constant gray value 524 (for example) as the profile is taken near the edge of region 504. Once the overshoot 508 is reached, the intensity becomes darker 526, and then becomes lighter in region 528 as there is no photomask in the vicinity.

If the defect region includes a 90-degree corner, such as in FIG. 4A, then an “edge overshoot at corner” value is computed in step 390. This is performed by examining the pixel intensities along a line of pixels going through the corner horizontally or vertically in both the test and reference images. This array of pixel intensities is called an intensity profile as seen in FIG. 4B. The profile goes from dark to bright or bright to dark at the corner. Sometimes the intensity has a spike at the corner, called an overshoot. The overshoot intensity spike is usually caused by a stitching error in the reference image, but occasionally is caused by optical aberrations that would occur equally in both images. Thus, if the reference image profile has more than twice the edge overshoot value of the test image profile at the corner it is then concluded that the reference image has a stitching error.

### Computer System Embodiment

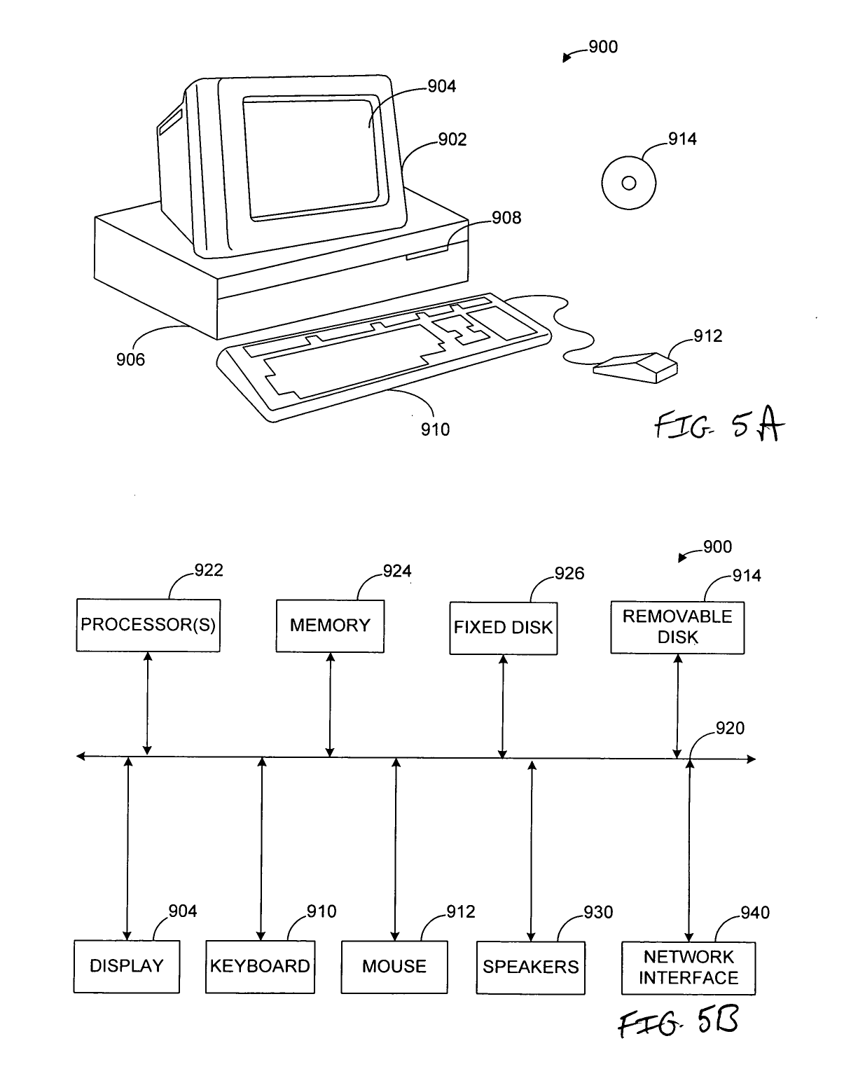

FIGS. 5A and 5B illustrate a computer system 900 suitable for implementing embodiments of the present invention. FIG. 5A shows one possible physical form of the computer system. Of course, the computer system may have many physical forms including an integrated circuit, a printed circuit board, a small handheld device (such as a mobile telephone or PDA), a personal computer or a super computer. Computer system 900 includes a monitor 902, a display 904, a housing 906, a disk drive 908, a keyboard 910 and a mouse 912. Disk 914 is a computer-readable medium used to transfer data to and from computer system 900.

FIG. 5B is an example of a block diagram for computer system 900. Attached to system bus 920 are a wide variety of subsystems. Processor(s) 922 (also referred to as central processing units, or CPUs) are coupled to storage devices including memory 924. Memory 924 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A fixed disk 926 is also coupled bi-directionally to CPU 922; it provides additional data storage capacity and may also include any of the computer-readable media described below. Fixed disk 926 may be used to store programs, data and the like and is typically a secondary storage medium (such as a hard disk) that is slower than primary storage. It will be appreciated that the information retained within fixed disk 926, may, in appropriate cases, be incorporated in standard fashion as virtual memory in memory 924. Removable disk 914 may take the form of any of the computer-readable media described below.

CPU 922 is also coupled to a variety of input/output devices such as display 904, keyboard 910, mouse 912 and speakers 930. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. CPU 922 optionally may be coupled to another computer or telecommunications network using network interface 940. With such a network interface, it is contemplated that the CPU might receive information from the network, or might output information to the network in the course of performing the above-described method steps. Furthermore, method embodiments of the present invention may execute solely upon CPU 922 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although the foregoing invention has been described in some detail for purposes of clarity of understanding, it will be apparent that certain changes and modifications may be practiced within the scope of the appended claims. Therefore, the described embodiments should be taken as illustrative and not restrictive, and the invention should not be limited to the details given herein but should be defined by the following claims and their full scope of equivalents.

I claim:

1. A method of distinguishing image errors in an optical inspection, said method comprising:
receiving a test image representing a photomask pattern;
receiving a defect region of said test image, said defect region being identified as including a potential defect in said photomask pattern;
receiving a reference image representing a believed ideal version of said photomask pattern;
computing a first spatial nonlinearity value of said defect region in said test image;
computing a second spatial nonlinearity value of said defect region in said reference image; and
determining that the image with the higher spatial nonlinearity value is the image that contains a defect.

2. A method as recited in claim 1 further comprising:
computing said first spatial nonlinearity value by calculating a first maximum pixel intensity difference between said test image and an auto-reference image of said test image; and
computing said second spatial nonlinearity value by calculating a second maximum pixel intensity difference between said reference image and an auto-reference image of said reference image.

3. A method as recited in claim 2 further comprising:
creating said auto-reference image of said test image and said auto-reference image of said reference image using a one-dimensional smoothing technique performed on said test image and said reference image, respectively.

4. A method as recited in claim 2 further comprising:
computing a plurality of auto-reference images corresponding to said test image; and
choosing the lowest maximum pixel intensity difference value as said first spatial nonlinearity value from among subtractions between each of said auto-reference images and said test image.

5. A method as recited in claim 1 wherein said reference image is of a die-to-die, a die-to-database, or a STAR type.

6. A method as recited in claim 1 wherein said defect region includes a straight edge of said photomask pattern or a clear area of said photomask pattern.

7. A method of distinguishing image errors in an optical inspection, said method comprising:
receiving a test image representing a photomask pattern, said test image including a defect region, said defect region being identified as including a potential defect in said photomask pattern;
receiving a reference image representing a believed ideal version of said photomask pattern;
searching said test image to find a repeated pattern that is similar to a pattern of said defect region;
creating an auto-reference image by manipulating said repeated pattern to match said defect region pattern;
computing a first maximum pixel intensity difference between the test image and said auto-reference image;
computing a second maximum pixel intensity difference between said reference image and said auto-reference image; and
determining that the image with the higher maximum pixel intensity difference is the image that contains a defect.

8. A method as recited in claim 7 wherein said repeated pattern is identical to said pattern of said defect region.

9. A method as recited in claim 7 further comprising:
manipulating said repeated pattern by shifting and rotating said repeated pattern.

10. A method as recited in claim 7 wherein said reference image is of a die-to-die, a die-to-database, or a STAR type.

11. A method as recited in claim 7 wherein said defect region includes a corner, circle or other complex pattern of said photomask pattern.

12. A method of distinguishing image errors in an optical inspection, said method comprising:
receiving a test image representing a photomask pattern, said test image including a defect region, said defect region being identified as including a potential defect in said photomask pattern;
receiving a reference image representing a believed ideal version of said photomask pattern;
defining a surrounding region of said test image that narrowly surrounds said defect region;
computing a first set of absolute difference values between pixel values in said defect region of said test image and pixel values in said defect region of said reference image;
computing a second set of absolute difference values between pixel values in said surrounding region of said test image and pixel values in said surrounding region of said reference image;
determining a first maximum value from said first set of values corresponding to said defect region, and determining a second maximum value from said second set of values corresponding to said surrounding region;
determining that a focus error or rendering error in said reference image exists if said second maximum value is more than about 70% of said first maximum value.

13. A method as recited in claim 12 further comprising:
computing a first intensity gradient of said test image at an edge of said photomask pattern in said defect region;
computing a second intensity gradient of said reference image at said edge of said photomask pattern in said defect region;
determining that a manufacturing error exists when it is determined that said first and second intensity gradients are nearly identical; and
determining that a focus or rendering error exists when it is determined that said first and second intensity gradient differ by more than about 10%.

14. A method as recited in claim 12 wherein said surrounding region is about 3 pixels wide.

15. A method as recited in claim 14 wherein said surrounding region is 3 pixels wide.

16. A method as recited in claim 12 wherein said reference image is of a die-to-die, a die-to-database, or a STAR type.
